(19) United States
(12) Patent Application Publication
(10) Pub. No.: US 2004/0113763 A1
(43) Pub. Date: Jun. 17, 2004

(54) Device for storing a visual sequence in response to a warning signal on board a vehicle

(76) Inventors: Claude Bendavid, Paris (FR); Eric Benhamou, Paris (FR); Michel Funaro, Vincennes (FR); Jean Rouch, Geneve-Suisse (FR)

Correspondence Address: William Anthony Drucker, Suite 800, 1901 L Street N W, Washington, DC, 20036-3506, US

(21) Appl. No.: 10/473,661

(22) PCT Filed: Mar. 26, 2002
(86) PCT No.: PCT/FR02/01049

(30) Foreign Application Priority Data
Mar. 30, 2001 (FR) 01/04611
Oct. 25, 2001 (FR) 01/14079

(51) Int. Cl. B60Q 1/00

(52) U.S. Cl. 340/436; 348/148

(57) ABSTRACT

The invention concerns a recording and/or storage device comprising at least a camera (V1 to V4) mounted on the vehicle (20) and designed to deliver continuously a series of images and an electronic circuit (21) capable of transferring at every moment, into a buffer (23), the images delivered by the camera (V1 to V4) so that at every moment, said storage contains a sequence of images photographed by the camera for a predetermined time interval preceding said moment, and an impact sensor (25). The transfer of the data contained in the buffer (23), into a storage memory (24) for subsequent playback can be performed in response to a command carried out by the driver or optionally automatically following detection of an impact.

The present invention concerns a device for recording and/or storing a visual sequence following the transmission of an alarm signal by a sensor situated on board a vehicle.

In particular, but not exclusively, it is applicable to the setting up of a visual indication for visualising the circumstances of an event, such as an impact occurring on a parked car or even a road accident and of subsequently deducing the causes and liabilities. It can be used by legally empowered persons, the police, road safety bodies and insurance companies. It makes it possible to considerably reduce the costs relating to enquiries and anything contributing and showing and determining the truth.

In fact, it is known that a large number of impacts received by cars or even road accidents remain unexplained, the parameters recorded after the accident (braking traces, position of the impact) not being able to sufficiently accurately retrace all the events which occur during the accident and identifying all the parties involved in this accident. Thus, this means that the perpetrator of a driving error causing an accident, even if he is not affected by the accident, can escape legal proceedings. He may even ignore the consequences, sometimes dramatic, of the error he has committed (even if in a large number of cases the responsibility for the accident is shared).

Therefore, first of all, the object of the invention is to resolve this problem by providing a device introducing at least one camera installed in such a way as to film at a normal images rate the space surrounding the vehicle and preferably the spaces situated at the front and rear of the vehicle, and to store a sequence of images delivered by the camera for a predetermined period of time and/or following the occurrence of an event, such as an impact affecting the vehicle and provoking the transmission by a sensor of a detection signal so as to be able to display after the impact the images taken by the camera during this period.

More specifically, this device introduces an electronic storage and processing circuit able to provide a first operating mode when the vehicle has stopped or is parked, said circuit including means:

for transferring into a buffer memory images delivered by the camera during a predetermined period following the transmission of the detection signal when the vehicle has stopped and/or is parked,

for transmitting an alarm signal so as to indicate that the sensor has transmitted a detection signal and that as a result a sequence of images concerning the circumstances of the impact is recorded in the buffer memory,

for enabling the driver to carry out a control action so as to provoke the transfer of the images contained in the buffer memory to the storage memory.

Advantageously, said electronic processing and/or storage circuit could include:

means for displaying the contents of the buffer memory prior to its possible transfer into the storage memory,

means for selecting and transferring into the storage memory a sequence originating from one of the cameras located in the buffer memory.

By means of these arrangements, the driver entering his car after having left it parked is advised by the alarm signal that during his absence the sensor for detecting an impact and accordingly a sequence of images able to determine the causes of the impact is recorded in the buffer memory (RAM).

The driver can then check if his vehicle has been damaged by the impact. If it has, he could trigger the transfer of the images contained in the buffer memory to the storage memory (unable to be falsified).

Then the driver could then proceed to reading of the images contained in the storage memory, for example on a computer or a GPS screen of the vehicle if the latter is equipped with same.

By successively visualising the sequences originating from the various cameras, the driver could determine which contains useful or advantageous information so as to be able to transfer the images from this camera onto a recording support, such as a cassette or flash memory card which he could send to his insurance company accompanied by a constat.

According to another characteristic of the invention, the electronic storage and/or processing circuit shall be designed so as to be able to provide a second operating mode corresponding to a “vehicle moving” state in which:

the cameras film continuously and transfer the images to the buffer memory so that when in a steady state condition, at each moment the buffer memory contains the image sequence taken by the cameras during a predetermined period of time preceding this moment,

the sensor acts on the electronic circuit during transmission of said detection signal so as to trigger the transfer of the data contained in the buffer memory into a storage memory where they are retained.

Advantageously, the first operating mode shall be triggered automatically when the general contact of the vehicle is cut and/or when no movement is detected.

Similarly, the triggering of the second operating mode could be triggered following the closing of the general contact of the vehicle and/or when a movement of the-vehicle is detected.

It proves that one of the most significant problems posed by the embodiment of a device of the type mentioned concerns the storage in real time of the digital data relating to the images delivered by the cameras.

In fact, the normal rate of cameras is 25 images per second and the number of pixels per image is at least 280,000 pixels (700×400). This means that for a black and white image with 8 levels of grey, 2,240,000 bits (8×280,000) are to be transferred, namely 56 Mbits for one second (25×2,240,000).

For a sequence of 1 mn, the contents of the buffer memory shall then be 56 Mbits×60=3.36 Gbits. Of course, these contents need to be multiplied by the number of cameras used and increased with the volume of bits relating to the additional information.

Moreover, having regard to the speed a motor vehicle can reach and in particular because accidents are frequently due to excess speeds, the device of the invention needs to be able to operate for speeds of about 200 kms/h or more. Now at this speed, (≈55 m/s), the path followed by the car between two successive images is ≈2 m. Note that the rate of 25 images/s is a minimum rate below which it shall be impossible to validly reconstitute the accident.

Having regard to this rate, the transfer of data between the camera and the storage device needs to be carried out at a high speed without it being possible to use any compression system : indeed such a system requires a processing time incompatible with the requirements of this application.

Furthermore, the use of certain types of memory, especially flash memories for which the transfer of data is carried out in series, is prohibited owing to the slowness of storing.

This is why the attempts to embody a device such as the one described previously have not been successful.

So as to resolve these problems, the invention offers using a storage and processing electronic circuit having a microcomputer structure equipped with a RAM memory for temporarily storing the digital data delivered by the cameras and whose capacity corresponds to the one previously mentioned, the transfer of the data relating to each pixel from the cameras to the microcomputer and the RAM memory being carried out in parallel so as to reduce the memory loading and transfer to a strict minimum.

Moreover, the storage memory could advantageously consist of a specially designed hard disk so as to resist strong impacts. The advantage of this solution consists in that it makes it possible to obtain extremely short transfer times compatible with this type of application.

Advantageously, said sensor consists of an impact sensor comprising an accelerometer, also able to be used for detecting movements of the vehicle.

In addition, the electronic circuit could be designed so as to record in the storage memory during the second operating mode the images taken by the camera during a predetermined period according to the transmission of the detection signal transmitted by the sensor.

Similarly, the storage and processing circuit could include means for associating with each stored image dating information and/or information relating to various parameters, such as the speed of the vehicle and/or the condition (activated or not) of the brakes.

There appears hereafter various embodiments of the invention given by way of non-restrictive example with reference to the accompanying drawings on which:

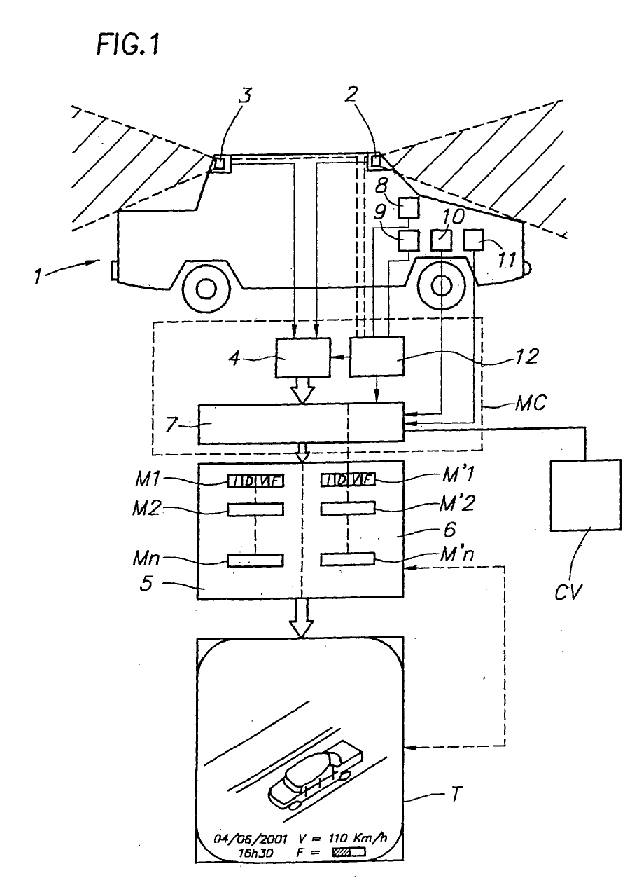

FIG. 1 is a diagram of a device according to the invention and equipping a motor vehicle;

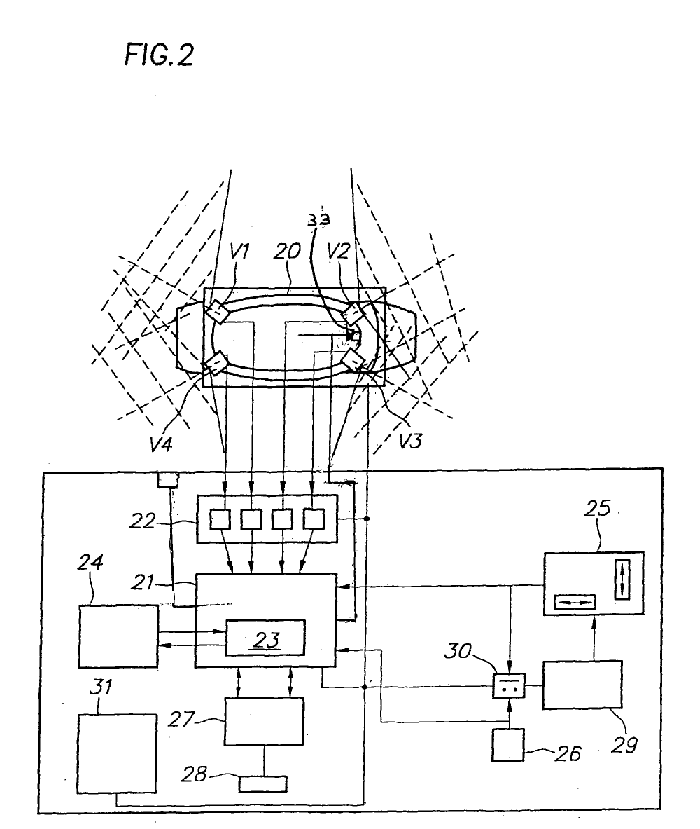

FIG. 2 is a diagram of an embodiment variant of the device of the invention.

In this example, the motor vehicle 1 is equipped with two cameras 2, 3 respectively placed in the upper portion of the windscreen and the backlight.

The images delivered by these two cameras 2, 3 are transmitted to an electronic processing circuit 4 connected to two storage units 5, 6 (for example the buffer memories possibly consisting of RAM type volatile memories) mounted in parallel by means of a digital messages composition element 7. The assembly including the electronic processing unit and the storage units 5, 6 and the message composition element may exhibit a structure similar to that of a microcomputer.

Advantageously, the transfer of the data relating to each pixel scanned by the camera to the electronic processing circuit is carried out in parallel so as to reduce as much as possible the transfer and storage times.

Each of the storage units 5, 6 has a capacity corresponding to a sequence of digital messages having a predetermined duration, for example between 0 second and 1 minute. Its structure is that of an FIFO battery in which the first information element introduced is the first extracted (the last item of information introduced provokes the extraction or deletion of the first re-entered item of information contained in the battery).

The digital message composition element 7 is also connected to a detection element 8 for detecting the state of the general contact of the car to an accelerometer 9 able to detect impacts and movements of the motor vehicle, to a speed counter 10, as well as to a detection device 11 for detecting the condition (braking/absence of braking) of the brakes.

This element 7 has been designed so as to compose a series of messages M₁, M₂ . . . Mₙ, M′¹, M′₂ . . . M′ₙ at a rate equal to that of a camera 2, 3 (for example 25 images/s), each digital message including an image 1 taken by the camera, dating data D and data V relating to the speed and condition of the brakes F.

The feeding of the cameras 2, 3 of the electronic processing circuit 4, the composition element 7 and the memory 5, 6 is ensured by a feed circuit controlled from a control unit 12 connected to the accelerometer and the sensor 8 for detecting the state of the general contact of the car.

The functioning of the previously described device is then as follows:

When the motor vehicle is started, the feed circuit takes into account the closing of the general feed contact, and after the possible detection of a movement by the accelerometer 9, provokes feeding of the entire device with electric current.

Because of this, at each moment each of the two memory units 5, 6 stores a new message so that, after a transitory period, it contains a sequence of messages including the images taken within a predetermined period of time (between 0 seconds and 1 minute), as well as the information previously mentioned associated with each of these images.

When a significant impact occurs, the accelerometer 9 sends to the composition and management element of the memory a signal which provokes the transfer of the contents of the memories 5, 6 into a storage memory, in this instance a hard disk.

The sequences contained in the storage memory or in the hard disk can then be extracted so as to be read later, for example on the screen of a conventional data processing terminal T.

During the reading of this sequence, the operator could carry out image stoppages, possibly zoomed, enabling him to display both the contents of the image and the instantaneous parameters (speed/hour/braking) as indicated on FIG. 1.

Of course, provisions could be taken to ensure that the information contained in the hard disk and in encryption means cannot be falsified so as to avoid any use of this information by unauthorised persons.

When the car stops, the accelerometric sensor 9 transmits corresponding information to the electronic processing circuit and the composition element which interrupts the composition of messages and their transmission to the memory 5, 6. At the same time, it is possible to cut feeding of the cameras 2, 3.

When an impact next occurs, the signal transmitted by the accelerometer 9 provokes the starting of the cameras 2, 3, the electronic circuit 4, the composition element 7 and the memory 5, 6.

This memory then records a double sequence of messages transmitted by the element 7 during a predetermined period of for example between 0 seconds and 1 minute depending on the moment the impact was detected.

At the end of this period, the management and composition element 7 of the memory 5, 6 generates a signal which provokes the transfer of the contents of the memories 5, 6 into a storage memory, here the hard disk.

In the same way as indicated previously, the sequence contained in the storage memory or hard disk could be extracted so as to be able to be read later so as to determine the circumstances of the impact and identity who caused the latter (reading of the registration plate of the car which produced the impact).

Advantageously, the assembly including the electronic processing circuit 4, the management and messages composition element 7 of the memory 5, 6 and the control unit 12 could be integrated in a microcontroller MC (indicated by the broken lines).

By way of option, the car could be further equipped with a display console CV for displaying the images filmed by the cameras. This arrangement enables the driver to see and avoid possible obstacles found on his route during a manceuvre.

In the example shown on FIG. 2, the device introduces four cameras V₁ to V₄ for example with an automatic iris lens. Two of these cameras V₂, V₃ are fixed to the front of the vehicle 20, whereas the other two V₁, V₄ are fixed to the rear.

These cameras V₁, V₄ are connected to a microcomputer comprising a microprocessor 21 by means of an interface circuit 22 including four parallel ports. This conventional type microprocessor 21 is associated with ROM dead memories and a live memory 23 with a large capacity, such as two Giga octets.

In addition, this microprocessor 21 is connected to a non-volatile and non-rewriteable memory 24 preferably consisting of a hard disk of for example ten Giga octets.

Indeed, the RAM memory 23 needs to be able to permanently store a sequence of images produced by the cameras V₁ to V₄ for a predetermine period of time for example 25 seconds.

The non-volatile memory 24 is then dimensioned so as to be able to store a predetermined number of image sequences, such as five.

The microprocessor 21 further receives information originating from firstly a biaxial accelerometer 25 sensitive to accelerations according to a longitudinal axis and a transversal axis, and secondly from a general contact switch 26 of the vehicle 20.

It is able to be connected to peripheral units by means of an interface 27 and to a conventional connector 28. This interface 27 is intended to recover the images stored in the non-volatile memory or the hard disk 24. It may include means for connecting a display unit for displaying in real time the images originating from the cameras V₁ to V₄ and possibly the image sequences stored in the non-volatile memory or the hard disk 24. This display unit could advantageously consist of a display unit of the GPS (Global Positioning System) of the vehicle.

The feeding of the set of the electronic circuits of this device is effected by means of a battery 29 having autonomy of between 5 and 10 minutes, itself fed from the battery of the car. This battery 29 is connected directly to the accelerometer 25 which carries out a permanent watch. On the other hand, the feeding of the other electronic circuits of the device is effected by means of a controllable switch 30 controlled by the accelerometer 25 and by the switch of the general contact 26 of the vehicle.

The assembly of the electronic circuit is preferably housed inside a sealed chamber able to resist fire and mechanical attacks. This chamber is equipped with a temperature adjustment device 31 introducing for example a Peltier effect cell. Indeed, this device proves to be essential owing to temperature gaps (winter, summer) which occur inside the car and which are beyond the required temperature range for a correct functioning of the used electronic circuits.

The functioning of the previously described device is then as follows:

According to the first operating mode with the vehicle being stopped or parked, only the accelerometric sensor 25 is fed by the battery 29 (watch mode), the switch 30 being open.

When an impact occurs having an amplitude exceeding a predetermined is threshold, the accelerometric sensor 25 closes the contact 30 so as to feed all the electronic circuits of the device. The microprocessor 21 stores in the buffer memory 23 the digital data delivered by the cameras V₁ to V₄ which then film the environment of the vehicle for a predetermined period of time. At the same time, the microprocessor 21 activates a warning circuit 33 intended to inform the driver that during his absence the sensor has detected an impact and that as a result a set of images likely to determine the causes of the impact is recorded in the buffer memory 23. This sound and/or visual warning signal can be triggered permanently or only when the driver opens his door so as to enter his vehicle.

The driver is then invited to examine the vehicle to know if it has been damaged by the impact.

If the vehicle is not damaged, the driver does not take account of the warning and the sequence stored in the buffer memory 23 shall not be transferred into the storage memory 24 (so as to avoid loading it for no effective purpose). Optionally, he could also provoke erasing of the buffer memory by pressing for example a button connected to the microprocessor 21.

On the other hand, if the driver observes the presence of a deterioration brought about by the impact, he could provoke the transfer of the images contained in the buffer memory 23 to the storage memory 24. This transfer can for example be obtained by pressing a button 34 connected to the microprocessor 21.

The storage memory 24, which cannot be violated and falsified, shall therefore contain information relating to the circumstances of the impact and thus will make it possible to subsequently know who caused said impact. This information shall then be assumed to originate from the camera best orientated with respect to the impact.

The driver could then read the images contained in the storage memory, for example on a portable computer connected to the connection means 28 or on the GPS (Global Positioning System) screen of the vehicle if the latter is equipped with said screen.

By successively visualising the sequences delivered by the cameras, the driver could determine which one contains useful or advantageous information concerning the impact. He could then transfer the images from this camera onto a recording support, such as a cassette or flash memory card via the connector 28. He could then send this support for example to his insurance compagny accompanied by a constat.

According to the second operating mode, the feeding of the entire electronic circuit with electric current is carried out following the detection of a movement by the accelerometric sensor 25 (with is continuously fed) and/or following action on the general contact 26 so as to start the vehicle.

The images taken by the cameras V₁ to V₄ are then transmitted via the interface 22 to the microprocessor 21 which stores them in the live memory 23 which at each moment contains the images delivered by the four cameras for a period of time, for example 25 seconds preceding this moment.

In the case where the accelerometer 25 then detects an acceleration revealing an impact having an amplitude exceeding a predetermined threshold, this microprocessor 21 stops the recording of the images in the live memory at the end of 5 seconds.

Then all the information included in the live memory 23 received during two successive time periods (for example 25 seconds and 5 seconds) is transferred into the non-volatile memory or the hard disk 24 by the microprocessor 21.

When the vehicle restarts the microprocessor 21, which receives start-up information originating from the general contact of the vehicle, it reinitialises the electronic circuits and in particular the live memory 23. On the other hand, it does not act on the non-volatile memory or hard disk which accordingly retains the previously recorded information. It then continues to record the images originating from the cameras V₁ to V₄ in the buffer memory.

This process could be repeated several times (for example five times) depending on the capacity of the non-volatile memory (or hard disk), that is until the non-volatile memory or hard disk 24 is full. Then it would be appropriate to change the non-volatile memory 24 of format it according to the procedure which shall have been established.

By means of the interface 27, the data loaded into the non-volatile memory or hard disk 24 could be transferred into the memory of a computer. This data could then be displayed on normal reading at the front and rear image by image by possibly zooming said images.

Of course, the microprocessor 21 could be connected, as in the preceding example, with various sensors detecting the actual parameters of the vehicle, even those relating to the driving of this vehicle.

These parameters could be displayed at the same time as the images so as to allow better understanding of the circumstances in which the impact occurs.

1. Device for storing a visual sequence following the transmission of a detection signal detected by a sensor (9) situated on board a stopped and/or parked vehicle, this device introducing at least one embarked camera (2, 3) for filming at a normal image rate the space surrounding the vehicle and for storing a sequence of images delivered by the camera (2, 3) for a predetermined period of time following said transmission so as to be able to display after impact the images taken by the camera (2, 3) during this period, characterised in that it includes a storage (5) and processing (4) electronic circuit able to provide a first operating mode when the vehicle is stopped and/or parked, said circuit including means:
to transfer into a buffer memory images delivered by the camera during a predetermined period succeeding the transmission of the detection signal,
to transmit an alarm signal to indicate that the sensor has transmitted a detection signal and that as a result a sequence of images concerning the circumstances of the impact is recorded in the buffer memory,
to enable the driver to carry out a control action so as to provoke the transfer of the images contained in the buffer memory into the storage memory.

2. Device according to claim 1,
characterised in that said storage and/or processing electronic circuit includes means for displaying the contents of the buffer memory prior to their possible transfer into the storage memory.

3. Device according to one of the preceding claims introducing several cameras,
characterised in that said electronic storage and/or processing circuit includes means for selecting and transferring into the storage memory a sequence derived from one of the cameras found in the buffer memory.

4. Device according to claim 1,
characterised in that the first operating mode is triggered following the closing of the general contact of the vehicle (26) and/or when a movement of the vehicle is detected.

5. Device according to one of the preceding claims,
characterised in that said electronic processing circuit is programmed so as to further obtain in alternation with the first operating mode a second operating mode corresponding to a “vehicle moving” state in which:
the camera (V₁ to V₄) films continuously and transfers the images to the buffer memory so that in a steady state at each moment the buffer memory (23) contains the image sequence taken by the camera (V₁ to V₄) during a predetermined period of time preceding this moment,
the sensor (25) acts on the electronic circuit during transmission of the detection signal so as to trigger the transfer of the data contained in the buffer memory (23) into a storage memory (24) in which said data is retained.

6. Device for storing a visual sequence following the detection of an accident able to occur at a speed ranging from 0 to 200 km/h (or more) by a sensor (9) situated on board of a vehicle, said vehicle being equipped with at least one embarked camera (2, 3) for filming the space surrounding the vehicle, and an electronic processing circuit (4) able to transfer into a buffer memory (5, 6) the images delivered by the camera (1, 2) so that in a steady state at any moment this buffer memory contains a sequence of images taken by the camera (1, 2) during a predetermined period of time able to reach two minutes preceding this moment, the sensor (9) acting on said electronic circuit at the time an impact is detected so as to trigger the transfer of the data contained in the buffer memory into a storage memory in which said data is retained, as well as display means for displaying after impact the images contained in the storage area, characterised in that:
the rate of images produced by the camera is at least 25 images/second so that the route covered by the vehicle between two successive images at a high speed in less than 2 m so as to validly restore the circumstances of the accident.
The transfer of the data relating to each pixel between the camera and the buffer memory is carried out at each moment in real time in parallel without the use of any compression system requiring an inadmissible processing time at a rate able to reach at least 56 Mbits/second.
The storage and processing circuit includes means able to associate with each image stored in the buffer memory certain parameters such as dating information and/or the speed of the vehicle and/or the condition of the brakes, this information being transferred into the storage memory at the same time as the images corresponding to them.
The storage memory consists of a hard disk which has been designed to resist significant impacts and exhibit extremely short transfer times, the capacity of this storage memory being provided so as to be able to store several sequences of images.
The display means have been designed so as to be able to carry out stoppages on images for displaying both the contents of an image and the instantaneous parameters associated with this image.

7. Device according to claim 6,
characterised in that said impact sensor (9) consists of a sensitive biaxial accelerometer according to a longitudinal axis and a transversal axis of the vehicle.

8. Device according to claims 6 and 7,
characterised in that said electronic circuit (21) is designed so that following the transmission of the detection signal transmitted by the sensor (25), it stops recording the images in the buffer memory (23) at the end of a second predetermined period of time and then carries out the transfer of the data recorded during the two successive periods (first and second) into the storage memory (24).

9. Device according to one of claims 6 to 8,
characterised in that, when the vehicle restarts after said detection, it reinitialises the buffer memory (23) and launches a program for retaining the information previously recorded on the hard disk (24).

10. Device according to one of the preceding claims,
characterised in that it includes at least two cameras (V₁ to V₄) (preferably two pairs) respectively mounted at the front and rear of the vehicle.

11. Device according to one of the preceding claims,
characterised in that the feeding of the camera (2, 3) of the electronic storage and processing circuit is ensured by a feed circuit controlled from a control unit (12) connected to the accelerometer and to a sensor 8 for detecting the condition of the general contact of the vehicle, this control unit being designed so that when the vehicle is started up, the feed circuit takes into account the closing of the general feed contact and, after the possible detection of a move by the accelerometer (9), provokes the feeding of the entire device with electric current.
